(19) United States
(12) Patent Application Publication
(10) Pub. No.: US 2003/0114946 A1
(43) Pub. Date: Jun. 19, 2003

(54) Electronic system for custom-reporting safety relief design parameters in a high pressure fluid flow environment

(76) Inventor: Edward M. Kitchen, Charlotte, NC (US)

Correspondence Address: Adams, Schwartz & Evans, P.A., 2180 Two Wachovia Center, Charlotte, NC, 28282, US

(21) Appl. No.: 10/319,000

(22) Filed: Dec. 13, 2002

Related U.S. Application Data
(60) Provisional application No. 60/341,397, filed on Dec. 13, 2001.

(51) Int. Cl. G06F 19/00

(52) U.S. Cl. 700/97; 700/301

(57) ABSTRACT

An electronic system is provided for custom-reporting safety relief design parameters in a high pressure fluid flow environment. The system includes an electronic database including design pressure data for protected units located in the environment. An electronic device calculates relief capacity for select overpressure scenarios in each of the protected units. The overpressure scenarios are selected from the group including thermal expansion, tube rupture, valve failure, pump dead head, blocked outlets, and fire case. The electronic device selects a relief device adapted to accommodate a maximum calculated relief capacity required for the selected overpressure scenarios in each of the protected units. The electronic device generates a custom report including data identifying at least one of the protected units located in the environment, the selected relief devices associated with the protected units, and the location of the protected units and relief devices in the environment.

This patent application claims priority to U.S. Provisional Patent Application Serial No. 60/341,397, filed on Dec. 13, 2001. This application relates to an electronic system for custom-reporting safety relief design parameters applicable in an industrial environment, such as a processing facility which manages high-pressure fluid flow. These facilities typically include piping and other pressure vessels applicable for conveying dangerous fluids in liquid, gas, and two-phase flows. The safety relief device is the single most important piece of equipment used in processing facilities to insure the safety and integrity of all pressure vessels subject to rupture and/or explosion. This safety device is generally the last defense against injury, loss of life, and costly property damage. Primary examples of safety relief devices include safety relief valves, rupture discs, and conservation vents. The present invention provides a fully automated and electronic method of calculating, documenting, and storing the relief system design in processing facilities.

### TECHNICAL FIELD AND BACKGROUND OF INVENTION

According to the Occupational Safety and Health Administration (OSHA), proper design documentation should accompany each safety relief device used in a processing facility to insure sufficient sizing of the orifice and its associated inlet and outlet discharge piping. Failure to generate such documentation is a serious problem in the industry. For Fortune 500 processing facilities, the average number of relief devices used in a single plant can well exceed 3,000. In the event of an explosion, the first thing OSHA generally requests is a copy of the relief system design record. When most of the early processing plants were designed, these design base calculations were not required, and consequently were not maintained by each facility. In 1992, OSHA mandated that safety relief system design and design base calculations be compiled and maintained for all processes using highly hazardous chemicals. Some companies, such as Dupont, apply this legal mandate across the board to include all chemicals, both hazardous and non-hazardous. Companies have even gone as far as to require that all documentation be completed by all of their processing facilities by year-end 2000. While these goals are admirable, in practice they have not yet been accomplished.

The present invention addresses a long-felt need in the industry for a fully automated and electronic method of calculation, documentation, and database storage of the entire relief system design in processing facilities. The invention performs scenario calculations to determine the worst-case cause of system overpressure. The invention handles the fire case for both liquid vaporization and gas expansion, thermal expansion for liquids, tube rupture for both liquids and vapors, and valve failure for liquids, vapors, gases, and steam.. The user can also input its own relief capacity requirements. The invention has a separate design engine for determining the required relief capacity for two-phase flow using methodology established by DIERS—a user group created under the auspices of the American Society of Chemical Engineers (AICHE). DIERS is the premier think tank for research and relief system design and documentation. The present invention has received DIERS certification for its design methodology.

Once the required orifice has been sized and an API or ASME standard orifice is selected, the invention uses the vendor-certified capacity to perform the required pressure drop calculations in accordance with ASME code. For liquids, the invention uses Sacham's pressure drop equation. For gases and vapors at sonic or subsonic velocity, the invention uses the Shapiro relationship and system data for determination of the inlet and outlet pressure drops to insure compliance with ASME code. The equations are listed in the Manual of Calculations and Formulae.

When all calculations are completed, the output is formatted to produce custom documentation, while the design, specification, and maintenance data is stored to a backend data repository. This repository is maintained on the user's server and can be accessed for quick retrieval and updating to accommodate changes in the process or piping conditions. The final report is a professionally formatted document that describes a device's set pressure, accumulation, overpressure scenarios, relief capacity, orifice size requirements and inlet/outlet pressure drop. The invention utilizes a novel report engine which offers the ability to extract any design, specification, and maintenance data from each design document in order to generate customized reports when needed.

Customized reporting is invaluable to effective Process Safety Management (“PSM”). PSM requires proper management of every aspect of the processing facility from personnel, equipment, piping, drawings, procedures, technology, and all issues that can affect the safety and integrity of the process. PSM regulations are mandated by the government to protect the safety of personnel in the work place. By offering immediate customized reports of the safety relief design, the invention is not only a design system but also a plant maintenance database that is usable on a daily basis to access and maintain design, specification, and maintenance details.

The invention will generate specification sheets along with detailed and summary reports for all calculations preformed. All process, design, and specification details are stored in a PSM report engine which can be customized and displayed in any selected format. A user may, for example, want to sort and print data by location #, node #, or flare # to analyze the relief system load or backpressure at a particular node or flare. Additionally, users may sort and print by scenario, to determine the most prevalent ruling cases—or sort by excess capacity, to determine which systems can handle future expansion. The invention's report engine is an invaluable tool for Process Safety Management and daily system monitoring and maintenance. The specification details make up the initial maintenance record that can be expanded to fit each facility's individual maintenance needs.

### SUMMARY OF INVENTION

Therefore, it is an object of the invention to digitally standardize the entire safety relief system design, selection, documentation, and storage process; and to create a completely integrated Process Safety Management system for maintaining relief system design, specification and maintenance records.

It is another object of the invention to provide a document and data management system for relief system design, specification, and maintenance records.

It is another object of the invention to provide a novel engineering software product which serves as a complete design, documentation and storage/retrieval solution for users.

It is another object of the invention to provide server-based digital solutions to a wide variety of problems, procedures, and standard methods of relief device calculation and documentation.

It is another object of the invention to provide a safety relief device design and documentation system which calculates the required relief capacity and orifice size needed to protect equipment from over-pressure scenarios like thermal expansion, tube rupture, valve failure, pump dead head, and fire cases.

It is another object of the invention to provide a safety relief device design and documentation system which accomplishes all the design and documentation requirements for a pressure safety relief system in significantly less time and at a fraction of the cost, as compared to existing techniques, while vastly improving the quality of the design calculations, documentation and storage system.

It is another object of the invention to provide a safety relief device design and documentation system which utilizes software that runs directly from the user's computer, and which utilizes a server only for authorization and billing purposes.

It is another object of the invention to provide a safety relief device design and documentation system wherein all design calculations and reports are saved on the user's computer and not on a server.

It is another object of the invention to provide a safety relief device design and documentation system that can evaluate up to 24 possible relief scenarios, using eight different fluids or eight different relief devices all simultaneously.

It is another object of the invention to provide a safety relief device design and documentation system including a web site which links to several major relief valve vendors, suppliers, or parts and service companies, as well as to OSHA 29CFR 1910.119, and other OSHA compliance laws.

It is another object of the invention to provide a safety relief device design and documentation system including a web site which links to the American Petroleum Institute (API) to observe recommended design practices; America Society of Mechanical Engineers (ASME), to search for code compliance issues; the Design Institute of Physical Property Research (DIPPR), to obtain physical property data; the Design Institute of Emergency Relief Systems (DIERS), to find the latest advances in relief system design; or the American Institute of Chemical Engineers (AICHE) to obtain other useful information in the chemical industry.

It is another object of the invention to provide a safety relief device design and documentation system which eliminates the human error factor prevalent with hand calculations.

It is another object of the invention to provide a safety relief device design and documentation system which gives the engineer a standardized method of performing relief device design calculations and documentation while meeting all legal and recommended documentation requirements.

It is another object of the invention to provide a safety relief device design and documentation system which allows the user to store the calculations and documentation on the user's server for easy access.

It is another object of the invention to provide a safety relief device design and documentation system which provides customized documentation output to meet the user's required template or standard reporting format for relief device design records.

It is another object of the invention to provide a safety relief device design and documentation system which offers relief valve and rupture disc design for ASME coded vessels. Sizing is based on API 520 and ASME sizing methods for liquids, gases, vapors, steam, and DIERS methodology for two-phase flow. Scenario selection and analysis allows the user to select from up to twenty-four possible relief scenarios including two-phase flow, fire cases, thermal expansion, tube ruptures, valve failures, blocked outlets, and any user input relief capacity.

It is another object of the invention to provide a safety relief device design and documentation system which includes a pipe sizing, and pressure drop routine for evaluating inlet and outlet piping.

It is another object of the invention to provide a safety relief device design and documentation system which utilizes a novel PSM database report engine that enables users to customize PSM reports based on any selected design and specification details.

It is another object of the invention to provide a safety relief device design and documentation system which will generate specification sheets along with detailed and summary reports for all calculations preformed.

These and other objects of the present invention are achieved in the preferred embodiments disclosed below by providing an electronic system for custom-reporting safety relief design parameters in a high pressure fluid flow environment. The system includes an electronic database including design pressure data for protected units located in the environment. Means are provided for calculating relief capacity for select overpressure scenarios in each of the protected units. The overpressure scenarios being selected from the group including thermal expansion, tube rupture, valve failure, pump dead head, blocked outlets, and fire case. Means are provided for selecting a relief device adapted to accommodate a maximum calculated relief capacity required for the selected overpressure scenarios in each of the protected units. Means are provided for generating a custom report including data identifying at least one of the protected units located in the environment, the selected relief devices associated with the protected units, and the location of the protected units and relief devices in the environment.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is a flow diagram showing the initial steps required to enter the system application;

FIG. 2 is a flow diagram showing the general input process for new data files;

FIG. 3 is a flow diagram showing the system steps for single-phase flow calculations;

FIG. 4 is a flow diagram showing the system steps for two-phase flow calculations; and

FIG. 5 is a flow diagram illustrating the PSM reporting engine.

### DESCRIPTION OF THE PREFERRED EMBODIMENT AND BEST MODE

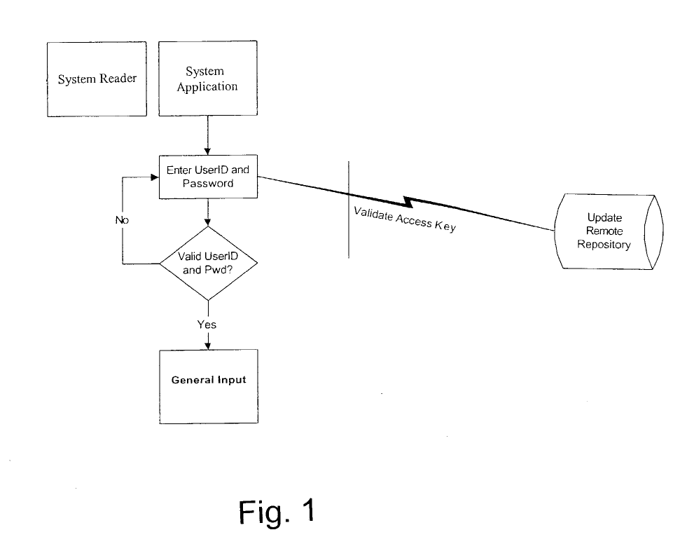

Referring now specifically to the drawings, an electronic system for safety relief device design, documentation and storage/retrieval (“System”) according to the present invention is illustrated in the flow diagrams of FIGS. 1-5. The System is an Internet-based electronic system which utilizes computer software applicable for selecting and documenting safety relief devices used in process plants to protect pressure vessels and piping (“protected units”) from catastrophic failure due to overpressure. Specific overpressure scenarios are directly associated with all protected units within a plant. “Overpressure” occurs when the protected unit is exposed to an internal pressure in excess of its design pressure. Safety relief devices, including relief valves, rupture discs, and conservation vents, provide an outlet to relieve this overpressure, and are generally the last line of defense in preventing possible explosions inside the plant.

System Overview

The proper selection and installation of safety relief devices is an integral part of the plant design. A typical plant may have thousands of safety relief devices. Periodic testing and maintenance is necessary to ensure that the chosen relief device associated with the protected unit is capable of handling the known causes of overpressure associated with that unit. Process Hazard Analysis/Reviews (Hazops) are required to identify potential hazards within all areas of the plant, and to document a course of action to protect against a potential catastrophic failure. Current and accurate documentation must be readily available to show that proper safety relief devices are in place throughout the facility.

While the System is unique to the processing industry, it follows industry standards as defined by the ASME (American Society of Mechanical Engineers) code, API (American Petroleum Institute) 520/521 Recommended Practices, DIERS (Design Institute of Emergency Relief Systems), OSHA (Occupational Safety & Health Administration) 29 C.F.R. 1910.119a, and “good engineering practices”. The term “good engineering practices” refers to those commonly accepted methods and procedures practiced by members of the engineering profession.

The System will handle liquid, gas, vapor, steam, and two-phase flow release scenarios for fire cases, thermal expansion, tube rupture, valve failure, pump dead head, and blocked outlets. The System will calculate the required capacity of each scenario not already input by the user, and will then calculate the required and standard orifice size and standard relief capacity for the protected unit. The System will then select the worst-case scenario, largest required orifice, as the basis for the design of the relief system to include the associated piping. The System also has a built-in piping program where the user can choose the number and type of fitting for both inlet and outlet piping. The System then calculates the piping resistance and pressure drop for this piping arrangement. The documentation results are produced instantaneously once all necessary data has been entered. The customized results are available in any selected format.

System Operation

Referring to FIG. 1, the System server is accessed via the Internet. By entering a preassigned user ID and password, licensed users can change system defaults and run custom calculations for all twenty-four (24) relief scenarios in addition to performing two-phase flow calculations. The two-phase flow calculations follow DIERS methodology by using HEM and/or Omega methods for determining the maximum flux rate and orifice size. Using a system storage utility, data files are saved to a searchable electronic database. The database provides access to all stored records at a glance to view critical information pertaining to each valve. A light “read only” version of the System allows unlicensed users to read, run, view, and print sample calculations.

The System incorporates a user-friendly, menu-driven Graphic User Interface (GUI) with the following three broad subject headings: Identification, Single Phase, and Two Phase.

I. Identification

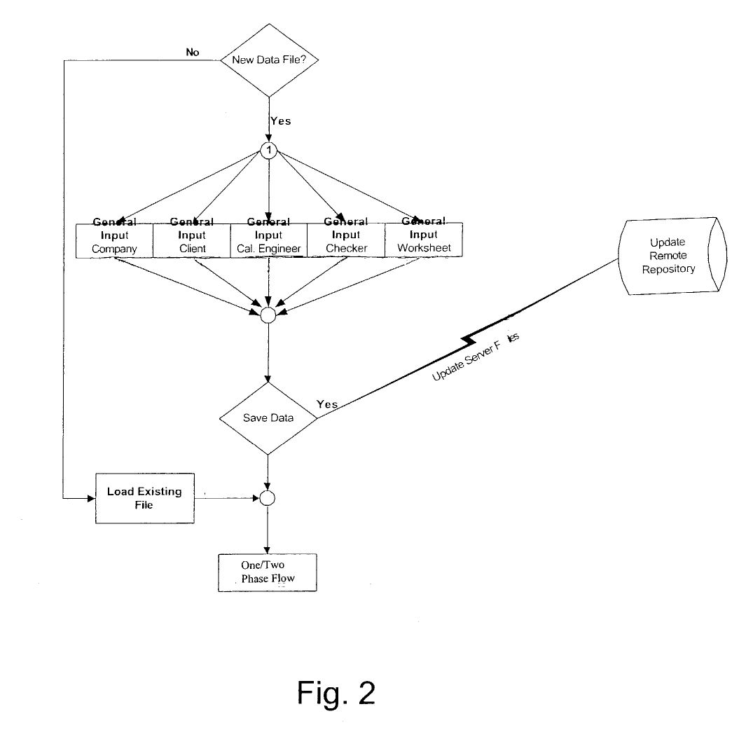

In the Identification section, the user inputs certain basic information such as the name of the company performing the calculations, the client name, the calculating engineer, the documentation checker, and specific information on the relief devices that make up the worksheet. See FIG. 2.

II. Single Phase

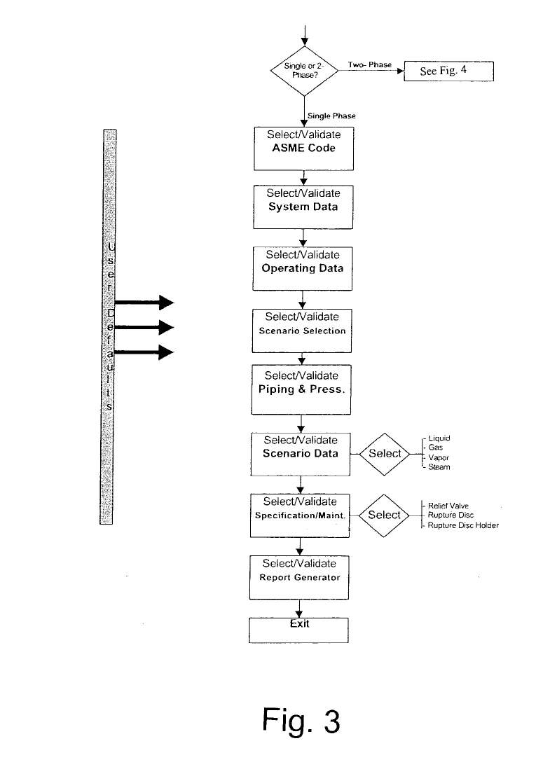

Under Single Phase, the user enters further data under the tab headings ASME Code, System Data, Operating Data, Scenario Selection, Piping/Pressure, Scenario Basic Data, Specification & Maintenance, and Production. See FIG. 3.

A. ASME Code

In the ASME Code screen, the user chooses the section of ASME code that is relevant to its calculation. The applicable codes under ASME are Section I, which involve boilers and vaporizers, Section IV, which involves hot water heaters, and Section VIII for pressure vessels types. In most cases, Section VIII of the ASME code will apply. Choosing the wrong section will not effect the calculation but will effect the documentation labeling and the perception of the reviewer.

The sizing of the relief valves for Section I and Section IV equipment is straightforward. Sizing is simply based on the heat input or output from the heater or boiler, and the amount of vaporization that can be caused by that heat input or output. For this capacity calculation, the user must enter the heat input or output in BTU/hr, and the heat of vaporization of the fluid at the relieving conditions (Btu/lb) to determine the worst-case capacity (lb/hr). The heat of vaporization of a fluid is the amount of heat required to vaporize one pound of a saturated liquid. In otherwords, for water, the heat of vaporization is the amount of heat required to change one pound of water at its boiling point to steam. Based on the heat rate, a rate of steam generation is calculated by simply dividing the heat input per hour, by the heat of vaporization, to give the amount of steam generation per hour. This capacity is usually denoted by the letter W (lb/hr), the heat of vaporization by the letters Hvap (BTU/lb), and the heat input by the letter Q (Btu/hr). The equation then becomes:

W(lb/hr)=Q(Btu/hr)/Hvap (BTU/lb)

This is how the relief valve capacity is calculated for Section I and Section IV valves. Using this capacity, a formula is used for determining the orifice size (hole) required to relieve that capacity using API 520 Recommended Practices for orifice Sizing.

For ASME Section VIII valves, the calculation is more complex. The engineer or designer must look at a list of possible over-pressure scenarios and determine which case is the worst-case scenario based on which will require the largest relief orifice. In most cases, fire is the worst-case possible scenario. If fire can be ruled out as a scenario, then the other scenarios will take precedence.

In addition to the fire case scenario, other typical scenarios include but are not limited to thermal expansion, tube rupture, valve failure, blocked outlets, runaway reaction, abnormal heat input, entrance of a volatile material, loss of cooling, loss of power, loss of air, and pump dead head. Each one of these scenarios may involve different types of releases including liquid, gas, vapor, steam, or two-phase release. The system program is designed to handle all of these releases.

B. System Data

In the System Data section, the user identifies the weak link in the chain of process equipment and piping between two block valves. The relief valve is then designed to open at a set pressure based on the equipment or piping with the lowest Maximum Allowable Working Pressure (MAWP) or Design Pressure. Pressure vessels are designed to handle pressures above the atmospheric pressure and must be ASME code stamped with its MAWP and its design temperature at that pressure. The relief valve may serve to protect several pressure vessels and piping, but will be set to open based on the vessel or piping with the lowest MAWP or design pressure. OSHA requires facilities to use “good engineering practices” for design and installation of pressure relief devices. The System uses the ASME code as “good engineering practices” as well as API 520 and 521 Recommended Practices. Additional system data includes the atmospheric pressure and any super-imposed backpressure, minimum and maximum. Also included in the system data is the temperature compensation multiplier used for determining the cold differential test pressure for a relief valve. If sizing for a rupture disc this variable is unity (1).

C. Operating Data

The Operating Data is used to look at the operating margin between operating conditions and relieving conditions. When sizing for a rupture disc, it is important to know the manufacture's recommended operating margin for the rupture disc selected. If operating too close to the bust pressure of the disc, then the disc can burst prematurely.

D. Scenario Selection

In the Scenario Selection screen, the user can select the relief scenarios it would like to analyze by simply clicking on that particular scenario. The program will then automatically give the user the required data fields necessary to calculate each scenario under the Scenario Basic Data section discussed below. In the present System, the user can select as many as 23 different relief scenarios. The System will determine the worst-case scenario for each release type, gas, liquid, vapor, and steam, and will convert that capacity to an air, water, or steam equivalent. This is done in order to compare those capacities against vendor certified capacities listed in vendor capacity tables. These capacities will be identical when using the correct vendor's discharge coefficients.

E. Piping/Pressure

ASME code requires the pressure drop in the piping system be minimal so that there is not a build-up of pressure in the piping system that would further increase the overpressure in the system or reduce the capacity of the relief device. Flow resistance in the inlet and outlet piping causes this pressure drop. The flow resistance is caused by the straight pipe, and the pipe fittings, such as elbows, tees, branches, and also due to elevation differences and velocity changes inside the pipe. All of this goes to make up the total resistance to flow inside the pipe. This total resistance can be expressed in two ways, either as a total equivalent length of straight pipe (L) or as a total resistance co-efficient (K). The two are related by the equation K=f (L/D), where f is the friction factor in the pipe, L is the equivalent length, and D is the diameter of the pipe in feet.

There are many correlations for determining the friction factor in the pipe. The system program uses the Colebrook &White correlation for determining the friction factor for liquids, and uses the Shapiro relationship for determining the friction factor and pressure drop for vapors and gases. The Shapiro relationship is the most interesting portion of the program subroutines, and is also used to determine the pressure drop for gases and vapors as well as the capacity required for the tube rupture scenario when vapor or gas is released.

Shapiro devised a set of formulas for determining the pressure drop/loss in a pipe based on the velocity difference at each end of the pipe relative to the speed of sound. Shapiro uses system data to describe the velocity of the fluid at each end of the pipe. It then uses a set of equations using these numbers to calculate the energy at each end of the pipe. From there, Shapiro relates the difference in energy between each end of the pipe to the total piping resistance inside the pipe. Therefore, by iterating these system numbers at each end of the pipe, until the difference in energy at each end of the pipe is equal to the total calculated piping resistance inside the pipe, the pressure drop is determined by convergence. For the tube rupture scenarios, the fluid flow rate is also iterated until the converged pressure drop is equal to the difference between the source pressure of the high-pressure fluid and the reliving pressure of that fluid.

To make the piping/pressure selection, the user chooses the target pressure drop as a percent of Pset, the pipe schedule, and pressure rating of the inlet flange of the relief device. For piping fields, the user chooses the pipe length, roughness, inlet flange size and pipe size, and finally the number and types of fitting for both the inlet and outlet piping. Pull-down menus are available to help choose the exact pipe size based on the pipe schedule selection.

F. Scenario Basic Data

Under the Scenario Basic Data heading, the user enters physical property data of the protected unit at the relieving temperature and pressure based on set pressure plus allowable over-pressure. The name of the fluid, the molecular weight, density, viscosity, and relieving temperature and pressure are all listed.

The user then determines orifice sizing by selecting either American Society of Mechanical Engineers (ASME) OR American Petroleum Institute (API). API and ASME have devised standard equations that are used to size an orifice once the required relieving capacity has been determined. The system program was designed to follow API 520 Recommended Practices for Orifice Sizing.

Once the required orifice has been determined, then a standard size orifice is selected from a list of standard orifice sizes available from vendors. Vendors use API and ASME standard orifice sizes. The user can therefore pick which standard it wishes to use when selecting a standard orifice size. In addition, the user must pick orifice coefficients used to determine the required orifice size. These orifice coefficients represent deviations from perfect discharge due to friction, viscosity, system backpressure, and multiple relief devices used in combination. After the required relief capacity is determined, the applicable equation from API 520 Recommended Practices for orifice sizing is performed. In the system program, the applicable equation is the API orifice sizing equation for vapors, gas, or steam. See API 520 Section 4.4 equation 2, 3, or 8.

The selection of the standard orifice is based on API and ASME standard orifice sizes. A chart shows the API and ASME standard orifice sizes and the inlet and outlet connection sizes for 150, 300, 600, 900, 1500, 2500 lb. Flanges built in the program.

The default Kd for ASME is 90% of the default Kd for API. The actual ASME orifice size for a selected orifice is actually the same orifice as the API, listed directly across the chart, although two different sizes are shown. ASME gives the actual orifice size, whereas API gives the “effective” orifice size. For the selection of the Kd, the default is 0.95 for API and 0.855 for ASME. The difference is 0.95(0.9)=0.855. The table indicates the difference between the ASME and the API as 0.855. Example: For the D orifice, the API size is 0.110 and the ASME size is 0.1279. This is because 0.1279(0.855)=0.1093, or about 0.11. The 0.855 is rounded-off to 0.86. Then, 0.1279(0.86)=0.10999, or about 0.110. For the E orifice, 0.2279(0.86)=0.19599, or about 0.1960. This can be done for every orifice size to move form API to ASME, except for the T orifice, which is a special case.

While liquids calculations are different from gases and vapors, the user still must first select which standard it wants the orifice to be sized for, and then chose the correct Kd which relates to that standard. However, in both cases, API and ASME, the user must input the Manufactures Kd, which is different for each valve manufacture. For one vendor's valves, the liquid Manufactures Kd is 0.744 for API, while the ASME is 0.669. In other words, 0.744(0.9)=0.699 not 0.669. Use caution when selecting the Manufactures Kd.

In addition to the physical property and orifice coefficients, the user must input specific data required for each scenario selected. This basic data is unique to each scenario.

The user must also enter the physical property data for liquid at the relieving temperature and pressure based on set pressure plus allowable over-pressure. Data entered includes the name of the fluid, the molecular weight, density, viscosity, and relieving temperature and pressure.

Basic Data—Thermal Expansion

Thermal expansion of liquids occurs when heat is absorbed by the liquid, thus causing the liquid to expand. This is only of concern when the vessel is blocked in full liquid. If the heat rate is high enough, the liquid will not only expand but will begin to vaporize as in the fire case liquid vaporization scenario discussed below.

Basic Data—Tube Rupture

The tube rupture scenario considers the case where a tube ruptures or breaks inside a shell and tube heat exchanger. If the maximum allowable working pressure (MAWP) of the shell and the tube are different, then either the shell or the tube must be protected form the operating pressure of the other. If the tube pressure is higher than the shell, and if the tube breaks, the high-pressure fluid in the tube will exit to the lower pressure shell. If, on the other hand, the shell has the higher pressure, then the high-pressure fluid in the shell will be driven inside the tube. In either case, the shell or the tube must be protected from the higher pressure fluid. API requires this scenario to be considered only when the high-pressure to low-pressure ratio is greater than 1.5. However, the system program will calculate the capacity regardless of this ratio if it is selected by the user.

The driving force of the high-pressure fluid is the pressure difference between the source pressure (Po) and the relieving pressure (P2). The resistances to this driving force are the ruptured tube piping itself and the exit or entrance losses as the fluid enters and exits the tube and tube sheet.

The system program allows the user to input the pipe resistances from each end of the tube in terms of tube diameter, absolute roughness, tube length, and resistance (K). These resistances are used along with the driving force, which is again the pressure drop (DP) between the source pressure and the relieving pressure, to find the required relief capacity (W) by an iteration technique. The program converges once the iterated relief capacity causes a pressure drop equal to the known driving force between the high-pressure source and the relieving pressure.

The system program actually calculates the relief capacity for each tube separately based on the difference in pipe resistances for each tube. The user must input separately each tube length and resistance (K) for each broken tube end. These two capacities are then added together to determine the total required relieving capacity for the relief device. For entrance and exit loses, the user should input a resistance (K) of 1.5 total, and for the tube length, input zero for one end, and the total length of the tube for the other end. This normally assumes the worst case scenario, which would mean that the tube breaks at the tube sheet. However, the user may experiment with this at its discretion.

For gas, vapor, and steam releases, the system program uses the Shapiro relationship for determining the friction factor. The flow rate is then iterated until the calculated pressure drop is equal to the pressure difference between the high and low-pressure sides of the exchanger.

Basic Data—Valve Failure

The valve failure scenario occurs when a valve fails open, thus causing a high pressure fluid buildup in a lower pressure vessel or piping. The driving force responsible for this required relief capacity is the pressure drop across the valve. This pressure drop is the difference between the upstream pressure in front of the valve and the relieving pressure of the fluid. Several formulas are used to determine the maximum flow capacity based on the valve's Cv, the properties of the fluid, and the pressure drop across the valve. The system program uses separate equations for liquids, gases, vapors, and for steam.

Basic Data—Pump Dead Head

For pump dead head, the user enters the pump dead head capacity for the pump in question. The program will then calculate the required orifice, and compare it to the other required orifice sizes for the other selected scenarios.

Basic Data—Blocked Outlets

For blocked outlets, the user enters the normal flow rate for the process that is restricted by the blocked outlet. The program will then calculate the required orifice and compare it to the other required orifice sizes for the other selected scenarios.

Basic Data—Other

For other scenarios, the user can enter the capacity for any scenario not calculated by the program. The program will then calculate the required orifice and compare it to the other required orifice sizes for the other selected scenarios.

In this section, the user can also select either a “Rating Mode” or “Design Mode”. In the rating mode, the user inputs a known relief device orifice size, and the System will calculate the capacity of that orifice using the proper orifice equations. This capacity is then compared against the other scenarios and the calculation proceeds as before. For design mode, the System simply uses the user-input capacity to calculate the required and standard orifice size.

Fire Case Scenario

The fire case scenario is perhaps the most widely used scenario. This scenario deals with the possibility of a fire that has engulfed the process facility. For the fire case one only need consider that portion of the vessel that is below 30 feet from grade. Any portion of the vessel that is above 30 feet (NFPA) OR 25 feet (API) from grade, is not considered to be exposed to fire unless inside of a building. The contents of the vessel are liquid, gas or a combination of both. During a fire, heat is absorbed through the vessel walls and into the fluid.

System and Physical Property Data

The fire cases are run as separate programs and are independent of all other scenarios. The fire cases do not share any of the system data, physical property data, or orifice data with any other scenario. The fire cases can therefore be run at different relieving conditions then the other release types, gas, liquid, vapor or steam. The reason for this is that the fire case is allowed under section VIII of the ASME code to be over-pressurized by 21% as compared to 6% for section I valves and 10% for section VIII. The user has the flexibility to run the fire case simultaneously with any other scenarios while using a different set of physical property data based on different relieving conditions.

Surface Area of Vessel

The first factor to consider is the total surface area of the vessel that is exposed to fire. This surface area is calculated based on the surface area of the vessel heads plus the area of the shell. The area of the heads depends on the type of heads used and there are formulas to calculate the area for each type. The area of the shell is based on the tangent-to-tangent (TT) height of the vessel multiplied by π; times the diameter (Area=pD*h). So the area of the shell plus the area of the heads is equal to the total area exposed to fire. Again, that portion of the area that is 25 or 30 feet (depending on code NFPA or API) above grade (ground level) is not included unless the vessel is inside a building. For vertical vessels, the user includes only that portion of the vessel wetted by the liquid level. And for horizontal tanks, the user calculates the total area of the vessel. The wetted perimeter factor (Fwp), discussed below, is then used to calculate the wetted perimeter of the horizontal tank.

Environmental Factors

The environmental factors are dependent upon the type and amount of fire fighting equipment that is being used in the area where the vessel is located. Depending on the type and amount of fire fighting equipment, such as exterior water spray, the code provides an environmental factor to adjust the amount of heat that could possibly absorb into the vessel. The Environmental Condition Factors are listed below.

| Environmental Condition | Kp |
|---|---|
| Bare Vessel | 1 |
| Approved Drainage and fire fighting procedures. | |
| Choose option in program to receive credit. | |
| Approved Insulation | 0.3 |
| Approved Water Spray and Drainage | 0.3 |
| Approved Insulation, Water Spray and Drainage | 0.15 |
| Earth Covered Storage | 0.03 |
| Underground Storage | 0 |

Environmental factors are also used for tanks having approved insulation that would reduce the maximum amount of heat absorbed. Credit for insulation cannot be taken unless it is capable of surviving the fire. This means that it must be of a high temperature type, such as calcium silicate, magnesia, mineral wool, or similar high temperature insulation. Fiberglass or cellular-glass is not suitable for credit as they will melt or break-up during a fire. Additionally, the insulation system must be able to take the forces of fire fighting, such as high velocity hose streams. Unprotected mineral block will wash off. A mastic-covered canvas or plastic vapor barrier covering will burn away leaving the insulation unprotected. Aluminum will melt. Generally only a stainless insulation cover attached with stainless or other high temperature alloy fasteners will provide credit for insulation in calculating the Environment Factor.

Wetted Perimeter Factors

The wetted perimeter factor (Fwp) has a value of one (1) for vertical tanks, and when the vessel content is a gas. The wetted perimeter factor is used for liquid filled tanks that are mounted horizontally. The wetted perimeter factor is used to determine the percent of the total area of the tank that will actually contain the liquid, wetted perimeter, due to it being mounted horizontally. This is another means of reducing the maximum possible heat absorbed by the vessel, hence the fluid for horizontally mounted tanks. Here, the logic is, if the vessel is 100% full then the liquid will create a wetted perimeter around the total inside surface of the vessel. If, on the other hand, the vessel is only 50% full then the liquid will wet only 50% of the total inside surface area of the vessel. This wetted perimeter factor is based on a formula that calculates the wetted surface area of the tank based on the percent fullness of the vessel. For spherically or other shaped tanks, the wetted perimeter factor must be calculated manually by the user.

Wetted Perimeter Factor (Fwp)

| % Volume | Fwp |
|---|---|
| 0 | 0 |
| 5 | 0.2 |
| 10 | 0.25 |
| 20 | 0.34 |
| 30 | 0.4 |
| 40 | 0.45 |
| 50 | 0.5 |
| 60 | 0.55 |
| 70 | 0.6 |
| 80 | 0.66 |
| 90 | 0.74 |
| 100 | 1 |

Vaporization of Liquid Contents—Vapor and Steam Release Types

If the content is a liquid, the worst-case scenario is for the heat input into the vessel to cause liquid to vaporize. The amount of vaporization depends on the how much heat is absorbed by the vessel. The total heat input into the vessel is based on a variety of factors and is the driving force for determining the required relief capacity.

Heat Input

The heat input into the vessel is based on one of several equations that are used in the industry. The most widely used is that from API which states that the heat input (Q) BTU/hr=21,000 times the Exposed Area to the 0.82 power: Q=21,000Arˆ 0.82. This equation is used when there are fire fighting procedures in place. If there are no fire fighting procedures in place, then the equation becomes 34,500Arˆ 0.82. In addition to the heat input from fire, there may be heat input from the normal operation of the process, Q (BTU/hr). The process may or may not include this heat input, but it must be included if there is normally heat input from the normal operation of the process.

Relief Capacity Determination

The relief capacity determination is calculated based on the total heat input into the vessel both from fire and from the normal process divided by the heat of vaporization of the liquid at the relieving pressure.

Fire Gas Case—Expansion of Gas Contents

If the content is a gas, the worst-case scenario is for the heat input into the vessel to cause the gas to expand thus over-pressurizing the vessel. The amount of expansion depends on how much heat is absorbed by the vessel. The total heat input into the vessel is based on a variety of factors and is the driving force for determining the required relief capacity.

Fire Gas Case—Relief Valve Factor (F)

The relief valve factor is the essential parameter in determining the required orifice needed to prevent over-pressures beyond the maximum allowable under ASME code. The relief valve factor is calculated based on the wall temperature of the vessel (Tw), the relieving temperature of the fluid(T1), the gas constant (C), and the valve manufacture's coefficient of discharge (Ko). The minimum value of the relief valve factor is 0.01 but can be calculated accordingly.

G. Specification & Maintenance

The system program will generate specification and maintenance sheets for relief valve, rupture disc and rupture disc holders. The program will transfer all the user input process data as well as the program-calculated values into the specification sheets. The user need only input the manufacture, model number, and materials of construction for the device or devices specified. The program automatically defaults to include all three types of specification sheets including:

1. Spring-loaded Pressure Relief Valve Sheet

2. Rupture Disc Design Sheet

3. Rupture Disc Holder Design Sheet

Alternatively, the user may choose not to include all three types of specification sheets. All three specification sheet inputs have both similar and unique data input fields.

H. Production

After entering all required data, the calculations are completed and the documentation is automatically created. The documentation is customized based on user selection of scenarios and piping configurations. The production gives all the system, operating, piping, and physical property data input by the user as well as the detailed calculation results for each scenario, orifice, and inlet/outlet piping and pressure drop calculation. The end of the report gives a summary of all calculations in an easy to read summary table. The documentation is displayed in a preview mode, which allows the user to view the completed documentation prior to printing it out.

III. Two Phase Flow

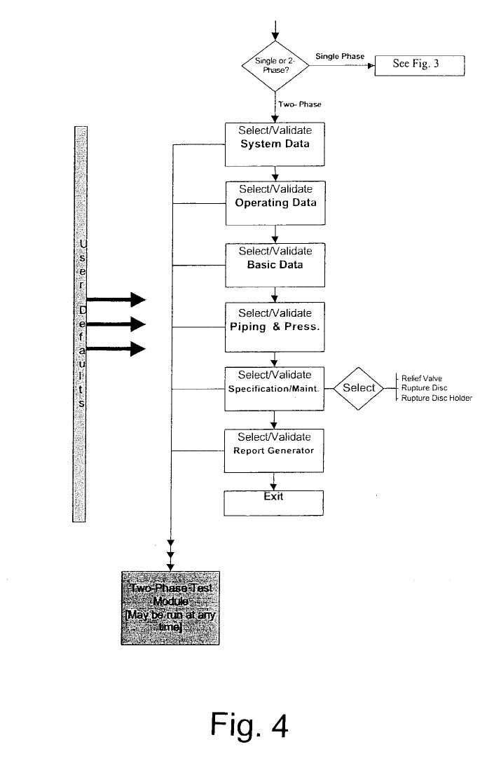

Referring to FIG. 4, in the Two-Phase Flow section of the program, the user can now test its single-phase design for the likelihood of two-phase flow. The two-phase test can be performed with only a few additional variables, the vapor and liquid densities, surface tension, the heat input from fire and the fire case required capacity. The correlating factor (Co), 1.0 conservative, 1.2 most likely, 1.5 unlikely but possible, is used as a parameter for the user to project the likelihood of two-phase flow.

The two-phase flow test will calculate the superficial gas velocity in the vessel (Vs), the transitional velocity (Ut), and bubble rise velocity (Uc). The transitional velocity is that velocity which moves the fluid from the Bubbly regime to the Churn turbulent regime. Using the superficial gas velocity and the bubble rise velocity, the dimensionless superficial gas velocity (Y) is calculated and compared with the dimensionless superficial gas velocity (Yr) at which two-phase flow is expected to commence. If the actual dimensionless gas velocity (Y) is greater than the expected two-phase dimensionless gas velocity (Yr), then two-phase flow is predicted. If two-phase flow is predicted, then the HEM model and or the Omega Method, discussed below, can be employed to determine the maximum gas flux (Gmax) during venting and the required orifice size. If the actual dimensionless gas superficial velocity is >20, then two-phase venting is also assumed due to a transition to droplet-dispersed flow, which has a homogenous nature.

HEM Model

If two-phase flow is predicted, then the user can select the Homogenous Equilibrium Model (HEM) to calculate the maximum flux rate (Gmax) during venting and the required orifice size. The HEM model is the most conservative model for sizing of the required orifice. It assumes the vapor fraction stays constant throughout the relief process.

Omega Method

The Omega Method is an algebraic approximation of the HEM model and is less conservative. The omega method starts by first calculating an Omega, which defines the degree of flash of a fluid.

| | |
|---|---|
| Omega > 1 | Flashing flow |
| Omega = 1 | Gas/Vapor flow |
| 0 < Omega < 1 | Non-flashing flow |
| Omega = 0 | Liquid flow |

Omega is calculated by determining the rate of change of specific volume with pressure change:

W=(dVₘᵢₓ−1)/(dP−1)

The system program uses the mass fraction of vapor and the density of the fluid at the estimated choke and relieving conditions to calculate the change in specific volume and hence the Omega.

Actual Required Orifice Size

The required area calculated for both the HEM Model and the Omega Method is based on perfect discharge from an orifice. The actual required area must be calculated based on the user's specified orifice coefficients. The program uses these coefficients to determine the actual required orifice size.

Piping and Pressure Drop

The two-phase program uses the same piping format as the single-phase piping data. Users can change the piping data as desired to view the output using a dual screen. The dual screen output can be viewed by clicking on a “Calculate & Report” button to view results.

The piping program will automatically choose the next larger standard orifice size, and will re-calculate the standard capacity based on the standard orifice size. It is the standard capacity which is used in the pressure drop calculations. The user can design its piping using the input data screen while at the same time viewing the pressure drop results in the output screen. The piping output gives a snapshot of the specific volume of the liquid, vapor, and mixture over the pressure range from relieving to 50% of back-pressure. The mass fraction of vapor (x), Omega, Beta and Gmax are calculated using the Omega Method.

When satisfied with the piping design, the user simply clicks on the Calculate Design button to generate a two-phase design based on the HEM model or the Omega method. If both HEM and Omega are chosen, the program will automatically show both results and will choose the most conservative as the basis for the design.

Back-Pressure Effects

Finally, once calculations are complete the user may check your design for the effects of back-pressure.

Sonic Flow

If the flow is sonic, the program will calculate the dimensionless parameter “N”, the total piping resistance. The user must then use a normalized chart to determine the value of “Gc/Gco”, which represent a nozzle to pipe flow ratio. The user must input this value of Gc/Gco and the program will calculate the reduced capacity due to the piping resistance. Different calculations are required and performed for subsonic flow.

HEM Piping

The System applies a rigorous method of analyzing the discharge piping using the homogenous equilibrium model similar to that used for the nozzle. The HEM model is rearranged to account for elevation and viscosity effects on overall discharge capacity.

The HEM piping model is a separate program than the HEM nozzle. It uses its own set of physical properties to fit the specific volume and viscosity data to a mathematical correlation. However, for the inlet piping the HEM model uses the same 2-point specific volume correlation and physical property constants as the nozzle. This is because the inlet piping conditions will be similar to the nozzle conditions and it makes sense to use the same data and correlations. But for the discharge piping there is typically a wider range of pressure variations between the nozzle and the discharge piping. Because of this difference, it is better to select a new set of specific volume and viscosity data that better reflects the discharge piping pressure range. This provides a better correlation to use in the HEM piping model. The HEM piping model is only as good as the physical property correlations it is based on. For this reason, the System uses a 3-point correlation for both the specific volume and the viscosity.

The System uses the initial mass fraction at relieving conditions and the enthalpy changes between the states to determine the mass fraction at the other two conditions. The user may also enter each mass fraction for each state directly instead of entering the enthalpy data to have the System calculate the mass fractions at those states. Once these mass fractions are determined, the System can then determine the mixture specific volumes at each state and can then fit these points to a specific volume model based on pressure. The same is done for the liquid viscosity at each pressure state.

The System uses two 3-point specific volume correlations. One is a simpler 3-point correlation that is used for turbulent flow and does not require a correlation for determining the mass fraction of vapor. The second 3-point correlation is more complex because it requires the vapor mass fraction correlation required for the laminar flow models. The laminar flow model takes into account the liquid viscosity resistance effects on discharge capacity.

Once the physical property data is fit to a particular correlation it can then be used in the HEM piping model. The System uses different HEM models for inlet and outlet piping and for turbulent and laminar flow regimes. The laminar model takes into account the viscosity resistance and its effects on the pipe flux.

The HEM piping model is then run using either the laminar or turbulent model and using the piping configurations, elevations and resistances for each pipe segment, inlet, outlet or total piping. The pressure drop is then determined by convergence. The HEM piping model will converge when the HEM pipe capacity based on the flux and pipe cross-section is equal to the nozzle capacity. The pressure at this point is recorded and subtracted from the initial HEM piping start pressure to obtain the pressure drop. If the HEM piping is unable to converge due to the maximum flux and pipe cross-section not able to meet the required nozzle flow, then the System will give a warning and request that the pipe size be increased or some piping resistance be eliminated.

User Schematic

The System further includes a Schematic screen under the tools menu where the user can develop a 2-D rendering of the pressure relief valve. This rendering can then be attached to the appropriate “*.CDS” file.

User Defined Defaults

One powerful advantage of the present System is the ability to configure the program to accept user-defined defaults and values. Because the system program contains so many variables and inputs, and recognizing that engineers have specific “niche” scenarios, the System allows the user to define commonly used defaults for multiple calculation aspects. The program adheres to a “define once, run many” philosophy to enable rapid calculations to be performed without redundant re-entering of data. The system allows the user to set specific user defaults by displaying a form that matches the program's input fields. This enables the System to always open using the user-specified defaults for all input variables. This is a tremendous function because it allows the user to use as defaults, any existing calculations or company standard examples. These existing calculations or company standard examples become the validation for the System, or helps to validate those existing calculations or standards.

Search Engine

The System utilizes a novel search engine which enables the user to view all of the system files created and stored within a directory. In addition to displaying the files, the System displays particular file attributes. The user has the option of either selecting a standard “File Open” (if the exact filename is known), or the enhanced “Open File with Search Engine” which will display other file attributes.

Examples of displayed attributes include:

1. File name

2. Equipment Number

3. Relief Valve Number

4. Rupture Disc Number

5. Flare Number

6. Node Number

7. Location Number

The search engine provides a “bird's-eye” view of the contents of the file. Users can double-click on a particular file in the grid and that file will automatically load, or they can simply click on any file in the grid, and then click on the “Open” button.

Custom Report Engine

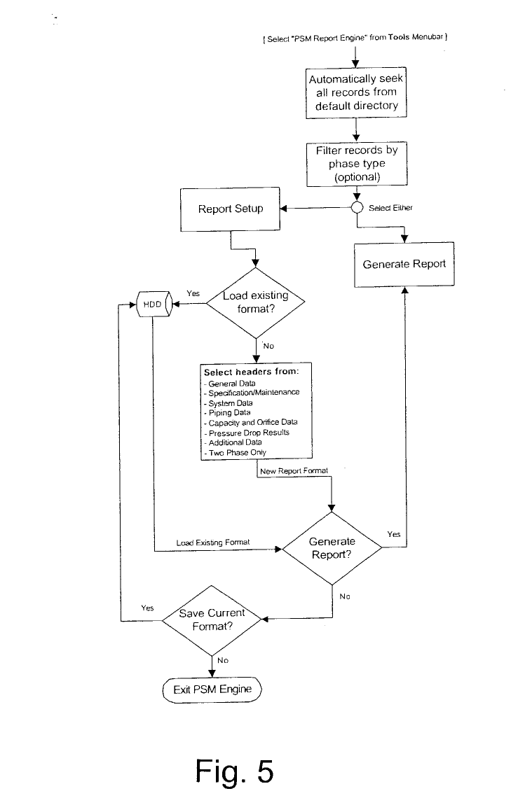

Referring to FIG. 5, managing and custom reporting the PSM critical relief system data is a key feature of the present System. Utilizing the system's novel report engine, users have the ability to select and display any number of variables in a report with full control over the report's customization. This unique reporting feature gives the user full PSM control over every aspect of its design, specification, and maintenance details. The report engine provides different views of one or more calculations, and enables the user to see all the fields associated with those calculation(s) or to selectively display only those fields the user wishes to see. This is an especially desirable tool for generating summary reports or finalized reports for presentation or archiving.

The Report Engine page is a split-screen including a Windows® file directory where the “*.CDS” files are stored, and a lower screen including a listing of all files found in the above directory. Before a report is generated, the user must first determine what kind of device and phase type reports it wants generated. A report can be based on Relief Valve, Rupture Disc, or both. Likewise, a choice between Single-Phase, Two-Phase or both phases can be made. Currently, the report engine defaults to all relief valves of single-phase type. If the user desires a more specific reporting view, the option(s) will have to be changed to extract/sort only those files having the selected device/phase characteristics.

Setting Up Report Layout

The report layout is setup by first selecting the headers to be displayed in the file. The System enables display of up to 21 different header fields, such as File Number, File Name, Phase Scenario Type, Equipment #, Relief Valve #, And Rupture Disc #. The user can select or deselect any field simply by clicking on the appropriate grid box.

Report Formatting Tab

The Report Formatting Tab enables the user to display the selected data in multiple sort columns. The user can sort by any three fields in ascending or descending sort direction. The report title may be specified and a grid displayed or left off, as desired.

Saving Report Layouts

Because considerable time may be spent setting up report formats, the System allows the user to save a format by simply clicking a “Save Format” button on the screen. Previously created and saved formats are recalled by clicking a “Load Format” button, and then selecting from the desired file.

Finally, the user can see the results of its selection(s) at any time by simply by pressing on the “Generate Report” button. The results are displayed in a preview screen that can be sent to the printer.

An electronic system for safety relief device design, documentation and storage/retrieval is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. An electronic system for custom-reporting safety relief design parameters in a high pressure fluid flow environment, said system comprising:
(a) an electronic database comprising design pressure data for protected units located in the environment;
(b) means for calculating relief capacity for select overpressure scenarios in each of the protected units, the overpressure scenarios being selected from the group consisting of thermal expansion, tube rupture, valve failure, pump dead head, blocked outlets, and fire case;
(c) means for selecting a relief device adapted to accommodate a maximum calculated relief capacity required for the selected overpressure scenarios in each of the protected units; and
(d) means for generating a custom report comprising data identifying at least one of the protected units located in the environment, the selected relief devices associated with the protected units, and the location of the protected units and relief devices in the environment.
